(19) United States
(12) Patent Application Publication
(10) Pub. No.: US 2022/0405129 A1
(43) Pub. Date: Dec. 22, 2022

(54) WORKFLOW SCHEDULING METHOD AND SYSTEM BASED ON MULTI-TARGET PARTICLE SWARM ALGORITHM, AND STORAGE MEDIUM

(71) Applicant: NANJING UNIVERSITY OF POSTS AND TELECOMMUNICATIONS, Nanjing (CN)

(72) Inventors: Dengyin ZHANG, Nanjing (CN); Yingjie KOU, Nanjing (CN); Chenhui SUN, Nanjing (CN); Yulian ZHANG, Nanjing (CN); Shibo KANG, Nanjing (CN)

(73) Assignee: NANJING UNIVERSITY OF POSTS AND TELECOMMUNICATIONS, Nanjing (CN)

(21) Appl. No.: 17/846,051

(22) Filed: Jun. 22, 2022

Related U.S. Application Data
(63) Continuation of application No. PCT/CN2022/094474, filed on May 23, 2022.

(30) Foreign Application Priority Data
Jun. 22, 2021 (CN) 202110690513.X

(51) Int. Cl. G06F 9/48; G06F 9/50; G06F 9/455; G06N 3/00

(52) U.S. Cl. CPC G06F 9/4881; G06F 9/5038; G06F 9/505; G06F 9/455; G06N 3/006; G06F 2209/505

(57) ABSTRACT

The present disclosure discloses a workflow scheduling method and system based on a multi-target particle swarm algorithm, and a storage medium. The method comprises the following steps that first, the difference between the frequency reduction characteristic and the execution time of each server in a cluster is considered; a multi-target comprehensive evaluation model covering workflow execution overhead, execution time and cluster load balance is constructed on the basis of a traditional model; second, a multi-target particle swarm algorithm is provided for workflow scheduling, and an efficient solving method is provided. The method alleviates the defects of premature convergence and low species diversity of the particle swarm algorithm, reduces the execution overhead and execution time of the workflow on the cluster server, and better balances the load of the cluster server.

### CROSS-REFERENCE TO RELATED APPLICATIONS

The application claims priority to Chinese patent application No. 202110690513.X, tiled on Jun. 22, 2021, the entire contents of which are incorporated herein by reference.

### TECHNICAL FIELD

The present disclosure specifically relates to a workflow scheduling algorithm based on a particle swarm optimization algorithm, which belongs to the technical field of cloud computing.

### BACKGROUND

Cloud computing is a resource sharing method provided by the Internet. Nearly unlimited resources are provided to the user terminal by using virtualization technology and simulating resources into virtual machines based on pay-as-you-go consumption mode, such as CPU, GPU, memory, storage and other resources.

At present, in the cloud computing system, resource management consists of two stages: resource allocation and resource scheduling. Resource allocation is to identify enough resources for the workload submitted by end users, and resource scheduling is the process of mapping the workload to the allocated resources and is the core module of cloud computing technology.

In recent years, researchers have devoted themselves to introducing meta-heuristic scheduling algorithms. Most of the algorithms mainly focus on the load-balanced supply of tasks to produce efficient resource utilization. However, this focus will increase the execution time of large-scale tasks, resulting in low scheduling efficiency of large-scale tasks. In addition, at present, most of the scheduling algorithms on the market only schedule a single problem, ignoring the comprehensive consideration. Moreover, the existing particle swarm algorithm on the market has a single population and is easy to fall into the local optimal solution, so that the final optimal deployment scheme cannot be obtained.

### SUMMARY

The technical problem to be solved by the present disclosure is how to reduce the probability of the scheduling algorithm falling into the local optimal solution and improve the accuracy of task deployment in the cloud computing system.

In order to solve the above technical problems, the present disclosure uses the following technical scheme.

A workflow scheduling method based on a multi-target particle swarm algorithm is provided, comprising the following steps:

1) constructing a workflow execution overhead evaluation equation;

2) constructing a workflow execution time evaluation equation;

3) constructing a cluster load evaluation equation;

4) constructing a comprehensive evaluation equation containing the indexes in the above three evaluation equations, and scheduling the workflow using the particle swarm optimization algorithm for the workflow execution overhead evaluation equation, the workflow execution time evaluation equation, the cluster load evaluation equation and the comprehensive evaluation equation, wherein the particle swarm optimization algorithm (PSO) divides the particle swarm into four parts evenly, it is assumed that each part of particles is iterated for C times, the first C*a% iterations of each part of particles search for the optimal solutions of the above four evaluation equations, respectively, the last C*(1−a%) iterations search for the optimal solution of the comprehensive evaluation equation, and the value range of coefficient a is [0,100].

A workflow scheduling system based on a multi-target particle swami algorithm is provided, comprising the following program modules:

an overhead evaluating module, which is configured to construct a workflow execution overhead evaluation equation;

an execution time evaluating module, which is configured to construct a workflow execution time evaluation equation;

a cluster load evaluating module, which is configured to construct a cluster load evaluation equation;

a solving module, which is configured to construct a comprehensive evaluation equation containing the indexes in the above three evaluation equations, and schedule the workflow using the particle swami optimization algorithm for the workflow execution overhead evaluation equation, the workflow execution time evaluation equation, the cluster load evaluation equation and the comprehensive evaluation equation, wherein the particle swarm optimization algorithm (PSO) divides the particle swarm into four parts evenly, it is assumed that each part of particles is iterated for C times, the first C*a% iterations of each part of particles search for the optimal solutions of the above four evaluation equations, respectively, and the last C*(1−a%) iterations search for the optimal solution of the comprehensive evaluation equation.

A computer readable storage medium is provided, which is used to store the workflow scheduling method based on the multi-target particle swarm algorithm described above.

Compared with the prior art, the present disclosure has the following beneficial effects.

The present disclosure provides a multi-target comprehensive evaluation model, which additionally considers the frequency reduction characteristics of servers and the differentiation characteristics of execution time of servers on the basis of the traditional model, and aims at reducing the execution time and the execution overhead of the workflow, optimizing the load balance of virtual machines, and improving the resource utilization rate of a cluster. Second, the present disclosure further provides a workflow scheduling algorithm based on the particle swarm optimization algorithm, which is different from the single-target particle swarm in the traditional particle swarm algorithm, and uses a new multi-target particle swarm, aiming at improving the population diversity of a particle swarm, expanding the scope of the search method of a particle swarm, reducing the probability of the scheduling algorithm falling into the local optimal solution and improving the accuracy of task deployment. In addition, this algorithm is different from the particle updating strategy in the traditional particle swarm algorithm, and uses Metropolis criterion in an annealing algorithm to update particles, aiming at improving the global search ability and the local search ability of a particle swarm. The algorithm uses the alternating update strategy to reduce the negative effect of the complexity increase caused by the multi-target particle swami, so that on the premise that the complexity of the algorithm is slightly higher than that of the traditional particle swarm algorithm, its performance can be fully exerted.

1) The present disclosure fully considers many factors such as the execution capability and the frequency reduction characteristics of cluster machines, constructs an evaluation equation more scientifically, and accurately evaluates the workflow deployment scheme, which effectively reduces the execution overhead and the execution time of the workflow on the cluster server and further balances the load of the cluster server.

2) The present disclosure alleviates the defects of premature convergence and low species diversity of the original particle swarm algorithm, and ensures that the obtained deployment scheme of the workflow is more accurate and reasonable when the algorithm is solved. In addition, the scheduling time is greatly shortened, saving the total scheduling and execution time of the workflow.

### BRIEF DESCRIPTION OF DRAWINGS

FIG. 1 is an exemplary workflow model of the present disclosure.

FIG. 2 is a flow chart of the operation of a particle swarm optimization scheduling algorithm according to the present disclosure.

### DETAILED DESCRIPTION OF THE EMBODIMENTS

The present disclosure will be further described with reference to the accompanying drawings hereinafter. The following embodiments are only used to illustrate the technical scheme of the present disclosure more clearly, rather than limit the scope of protection of the present disclosure.

### Embodiment 1

The workflow scheduling method based on the multi-target particle swarm algorithm according to the present disclosure comprises the following steps:

1) constructing a workflow execution overhead evaluation equation;

2) constructing a workflow execution time evaluation equation;

3) constructing a cluster load evaluation equation;

4) constructing a comprehensive evaluation equation containing the indexes in the above three evaluation equations, and scheduling the workflow using the particle swarm optimization algorithm for the workflow execution overhead evaluation equation, the workflow execution time evaluation equation, the cluster load evaluation equation and the comprehensive evaluation equation, wherein the particle swarm optimization algorithm (PSO) divides the particle swarm into four parts evenly, it is assumed that each part of particles is iterated for C times, the first C*a% iterations of each part of particles search for the optimal solutions of the above four evaluation equations, respectively, and the last C*(1−a%) iterations search for the optimal solution of the comprehensive evaluation equation. In the process of searching for the optimal solution, the annealing probability formula is used to update the state information of each particle.

The optimized target function is constructed.

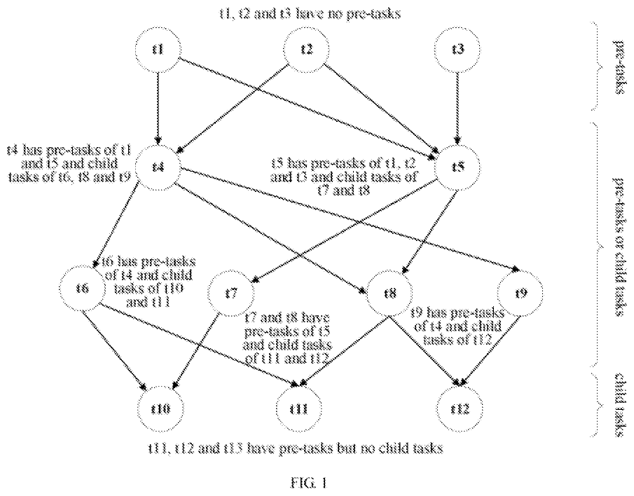

As shown in the workflow simulation diagram in FIG. 1, each ball t represents a task, and the workflow is a combination of several tasks t₁, t₂ . . . tₙ. For the workflow, most tasks are interdependent, and the workflow is represented by a weighted directed acyclic graph G=(T, E), where T={t₁, t₂ . . . t_{N}} represents N tasks of the workflow, and E={eᵢⱼ|i,j=1, . . . N} represents the dependency of the task. For example, e₁₂ indicates that the task t₁ completes execution, and the task t₂ can only be executed after the data is transmitted to the task t₂. Assuming that virtual machines are represented by vmᵢ, in which , i=1,2 . . . M, where M is the number of virtual machines.

The formula of the execution time of each task is as follows:

$$E \text{?} = \frac{\text{?}}{\text{?}} \qquad ( 1 )$$

$$E \text{?} \leq \text{?} \qquad ( 2 )$$

$$\text{?} \text{indicates text missing or illegible when filed}$$

where Lᵢ, represents the instruction length of the task tᵢ, Cᵥⱼ represents the execution capability (MIPS) of the virtual machine vmᵢ, RPᵥₘ, represents the attenuation coefficient of the virtual machine vmᵢ (the server cannot work at the maximum workload for a long time), ET_{i,vm}, represents the execution time of the task tᵢ in the virtual machine vmᵢ, and the execution time ETₜ_{ᵢ} of each task cannot exceed the deadline deadlineₜ _{ᵢ} of the respective task tᵢ.

The formula of data transmission time for a pre-task and a post-task is as follows:

$$TT \text{?} = \{ \begin{matrix}\frac{TR \text{?}}{bw} & i \neq j \\ 0 & i = j\end{matrix} \qquad ( 3 )$$

$$\text{?} \text{indicates text missing or illegible when filed}$$

where bw represents the network bandwidth of the cloud server, TR_{c}_{ₙ} represents the size of data transmitted from the task [symbol] to the task [symbol] , and [symbol] represents the time it takes for the task [symbol] to complete data transmission to the task [symbol] .

In step 1), the workflow execution overhead evaluation equation includes the workflow execution overhead and the data transmission cost of a pre-task and a post-task, and the formula is:

$$Cos t = {{\sum }_{\text{?}}}^{M} {\sum }_{\text{?}}^{N} k \text{?} ⋆ ET \text{?} ⋆ Price \text{?} + {{\sum }_{j = 1}}^{N} {\sum }_{i = 1}^{PR \text{?}} TT \text{?} ⋆ {Price}_{IE} \qquad ( 4 )$$

$${k}_{{t}_{l} {vm}_{j}} = \{ \begin{matrix}1 & {t}_{i} is executed on {vm}_{j} \\ 0 & {t}_{i} is not executed on {vm}_{j}\end{matrix} \qquad ( 5 )$$

$$Cos t \leq revenue \qquad ( 6 )$$

$$\text{?} \text{indicates text missing or illegible when filed}$$

where the number of tasks in the workflow is N, the number of virtual machines is M, [symbol] is a two-dimensional variable, [symbol] represents the execution time of the task [symbol] in the virtual machine [symbol] , [symbol] represents the execution cost coefficient of a task in a virtual machine [symbol] , which is used to represent the overhead per unit time of a server executing a task, [symbol] represents the time it takes for a task to complete data transmission to a task [symbol] , [symbol] represents the data transmission cost of two tasks in a cloud server network, which is used to represent the network overhead per unit time of data transmission, [symbol] represents all the pre-tasks of the task [symbol] , and the total overhead Cost of the workflow does not exceed the overhead limit revenue of a user.

In step 2), the completion time of the task [symbol] is represented by [symbol] , and the execution time of the workflow is represented by the maximum completion time of its subtasks [symbol] , in which the target equation of the completion time of the task [symbol] includes the execution time and the waiting time of the task [symbol] , the waiting time of the task [symbol] includes the maximum execution time of all pre-tasks and the data time transmitted from all pre-tasks to the post-tasks, and the formula is as follows:

$$WT \text{?} = {\sum }_{\text{?}}^{PR \text{?}} TT \text{?} + {max}_{\text{?}} \{ {ET}_{kvm} \text{?} \} \qquad ( 7 )$$

$$\text{?} \text{indicates text missing or illegible when filed}$$

where [symbol] represents the waiting execution time of the task [symbol] , [symbol] represents all the pre-tasks of the task [symbol] , [symbol] represents the time it takes for the task [symbol] to complete data transmission to the task [symbol] , and [symbol] represents the execution time of [symbol] on [symbol] ; [symbol] represents the execution time of all pre-tasks of the task [symbol] on [symbol] (this is a set), and the maximum value is selected from the set.

The completion time of the task [symbol] is by [symbol] , and the formula is as follows:

$$Makespan \text{?} = WT \text{?} + ET \text{?} \qquad ( 8 )$$

$$\text{?} \text{indicates text missing or illegible when filed}$$

where [symbol] represents the waiting execution time of the task [symbol] , and [symbol] represents the execution time of [symbol] on [symbol] .

The execution time evaluation equation of the workflow is as follows:

$$Makespan = {{max}_{i = 1}}^{N} \{ Makespan \text{?} \} \qquad ( 9 )$$

$$\text{?} \text{indicates text missing or illegible when filed}$$

where the number of the workflow tasks is N, [symbol] represents the maximum completion time of the task [symbol] .

In step 3), the load balance evaluation equation is established according to the difference of the execution time of the server, that is, it is expressed by the variance of the task execution time of a single virtual machine and the average task execution time of a virtual machine cluster, and the smaller variance indicates that the server load is more balanced, in which the total time equation of the execution task of a single virtual machine is as follows:

$$ET \text{?} = {\sum }_{j = 1}^{N} k \text{?} ⋆ ET \text{?} \qquad ( 10 )$$

$$k \text{?} = \{ \begin{matrix}1 & {t}_{j} is executed on {v}_{i} \\ 0 & {t}_{j} is not executed on {v}_{i}\end{matrix} \qquad ( 11 )$$

$$\text{?} \text{indicates text missing or illegible when filed}$$

where the total number of tasks in the workflow is N, [symbol] is a two-dimensional variable, and [symbol] represents the execution time of [symbol] on [symbol] .

The average task execution time [symbol] of the virtual machine is:

$${AVE}_{ET} = \frac{{{\sum }_{\text{?}}}^{M} {\sum }_{\text{?}}^{N} k \text{?} ⋆ ET \text{?}}{M} = \frac{{\sum }_{i}^{M} ET \text{?}}{M} \qquad ( 12 )$$

$$\text{?} \text{indicates text missing or illegible when filed}$$

in the above formula, the number of tasks in the workflow is N, the number of virtual machines is M, [symbol] represents the execution time of [symbol] on [symbol] , [symbol] is a two-dimensional variable [symbol] represents the total time of the task execution in the virtual machine [symbol] .

The maximum load target equation of the server cluster is expressed by the variance of the execution time of each virtual machine workflow and the average execution time of the total virtual machine workflow, and the equation expression is as follows:

$$LD = \frac{\sqrt{{\sum }_{i = 1}^{M} {( ET \text{?} - {AVE}_{ET} )}^{2}}}{M} \qquad ( 13 )$$

$$\text{?} \text{indicates text missing or illegible when filed}$$

where the number of virtual machines is M, [symbol] represents the total time of task execution of the virtual machine [symbol] , [symbol] represents the average time of the task execution of the virtual machine, LD represents the workload of the virtual machine cluster, and the smaller LD indicates that the load of the virtual machine is more balanced.

In step 4), the workflow comprehensive evaluation equation consists of the workflow execution overhead evaluation equation, the workflow execution time evaluation equation and the cluster load evaluation equation, and the equation expressions are as follows:

Fitness=x₁*Cost+x₂*Makespan+x₃*LD (14)

Cost≤revenue (15)

Makespan≤D (16)

where [symbol] , [symbol] , and [symbol] are the overhead weight coefficient, the time weight coefficient and the cluster load weight coefficient, respectively, and the weight coefficient varies with the characteristics of the task; Cost represents the workflow execution overhead; D represents the deadline of the workflow; Makespan represents the workflow execution time, and LD represents the workload of the virtual machine cluster.

In step 4), a particle swarm optimization algorithm is constructed.

The particle swarm algorithm is a meta-heuristic algorithm that uses multiple particles to simulate the behavior of birds searching for food. Each particle can be regarded as a searching individual in the N-dimensional search space, and the current position of the particle is a candidate solution of the corresponding optimization problem. The flight process of the particle is the searching process of the individual. The flight speed of the particle can be dynamically adjusted according to the historical optimal position of the particle and the historical optimal position of the population. Particles only have two attributes: speed r and position x. The optimal solution searched by each particle individually is referred to as the individual optimal solution, and the optimal individual extremum in the particle swarm is the current global optimal solution. The speed and the position are constantly iteratively updated. Finally, the optimal solution satisfying the termination condition is obtained.

The formula of the traditional particle swarm algorithm is as follows:

$${v}_{i , d}^{t + 1} = ω \text{?} v \text{?} + {r}_{1} {c}_{1} ( p \text{?} - x \text{?} ) + {r}_{2} {c}_{2} ( g \text{?} - x \text{?} ) \qquad ( 17 )$$

$${x}_{i , d}^{t - 1} = {x}_{i , d}^{t} + {v}_{i , d}^{t + 1}$$

$$\text{?} \text{indicates text missing or illegible when filed}$$

where d represents the dimension of the particle, [symbol] represents the speed of the d-dimension of the i-th particle in the t-th iteration, and [symbol] represents the position of the s-dimension of the i-th particle in the t-th iteration; [symbol] and [symbol] are the acceleration constant I and the acceleration constant 2, respectively, [symbol] is the individual learning factor of each particle, [symbol] is the social learning factor of each particle, and generally c, and c, are constants in the range of (0, 4); [symbol] and [symbol] are the random number I and the random number 2 in the range of (0, 1), respectively, [symbol] represents the individual extreme value of the evaluation equation of the d-dimension of the i-th particle in the t-th iteration, [symbol] represents the global extreme value of the evaluation equation of the d-dimension in the t-th iteration, and to is referred to as the inertia factor with a non-negative value. The larger the inertia factor, the stronger the global optimization ability but the weaker the local optimization ability. The smaller the inertia factor, the weaker the global optimization ability but the stronger the local optimization ability:

$${ω}^{t} = ( {ω}_{start} - {ω}_{end} ) ( C - t ) / C + {ω}_{end} \qquad ( 18 )$$

where to ω′ represents the value of the inertia factor ω in the t-th iteration, [symbol] =0.9 is the initial value of the inertia factor ω, [symbol] =0.4 is the final value of the inertia factor ω, C represents the total iteration number, and t represents the current iteration number.

The probability formula of the traditional simulated annealing algorithm is:

$$p ( x \text{?} \to x \text{?} ) = \{ \begin{matrix}1 & f ( x \text{?} ) < f ( x \text{?} ) \\ e \text{?} & f ( x \text{?} ) \geq f ( x \text{?} )\end{matrix} \qquad ( 19 )$$

$$\text{?} \text{indicates text missing or illegible when filed}$$

where [symbol] represents the probability that [symbol] transitions to [symbol] . If a target function is [symbol] , the transition probability is 1. If [symbol] ≥ [symbol] the transition probability is

$${e}^{- \frac{f ( {x}^{t + 1} ) - f ( {x}^{t} )}{{T}^{t}} ,}$$

T′ represents the annealing temperature of the t-th iteration, which varies with the iteration number, and the variation formula is as follows:

$$T \text{?} = 100 ⋆ e \text{?} \qquad ( 20 )$$

$$\text{?} \text{indicates text missing or illegible when filed}$$

The present disclosure uses the natural cooling equation of water from 100 degrees Celsius to 0 degrees Celsius for the change in temperature T′ in the formula, where t represents the current iteration number and n represents the number of particle swarms.

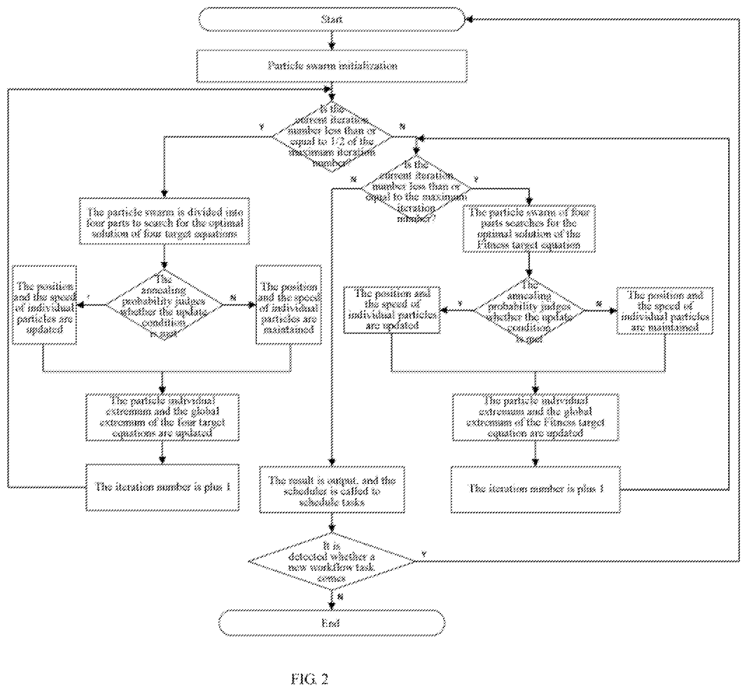

The specific execution flow of the particle swarm optimization scheduling algorithm according to the present disclosure is as shown in FIG. 2:

step 1), the particle swarm initializing the total iteration number C, the inertia factor ω, the acceleration constant [symbol] and the acceleration constant [symbol] , the random number [symbol] and the random number [symbol] , t=1, the particle grouping coefficient k=0 , i=1, initializing the number n of the particle swarms, randomly generating n particles, representing the individual extremum [symbol] of particles using the execution overhead evaluation equation and the global extremum [symbol] of particles using the execution overhead evaluation equation by the execution overhead evaluation equation Cost, representing the individual extremum [symbol] of particles using the execution time evaluation equation and the global extremum [symbol] of particles using the execution time evaluation equation by the execution time evaluation equation Makespan, representing the individual extremum [symbol] of particles using the cluster load evaluation equation and the global extremum [symbol] of particles using the cluster load evaluation equation by the cluster load evaluation equation LD, representing the individual extremum [symbol] of particles using the workflow comprehensive evaluation equation and the global extremum [symbol] of particles using the workflow comprehensive evaluation equation by the workflow comprehensive evaluation equation Fitness, and each dimension of particles represents each workflow;

step 2), judging whether the iteration number is less than or equal to C*a%, otherwise, jumping to step 3; starting to update the speed v and the position x of n particle swarms using For loop i=1:n , and in order to reduce the negative effect of the complexity increase caused by the multi-target particle swarm, using an alternating update method:

when i=⁴k+1:

the particle uses the following evaluation equation:

$$Cos t = {{\sum }_{\text{?}}}^{M} {\sum }_{\text{?}}^{N} k \text{?} ⋆ ET \text{?} ⋆ Price \text{?} + {{\sum }_{j = 1}}^{N} {\sum }_{i = 1}^{PR \text{?}} TT \text{?} ⋆ {Price}_{IE} \qquad ( 21 )$$

$$\text{?} \text{indicates text missing or illegible when filed}$$

where the number of tasks in the workflow is N, the number of virtual machines is M, [symbol] is a two-dimensional variable, [symbol] represents the execution time of the task [symbol] in the virtual machine [symbol] , [symbol] represents the execution cost coefficient of a task in a virtual machine [symbol] , which is used to represent the overhead per unit time of a server executing a task, [symbol] represents the time it takes for a task [symbol] to complete data transmission to a task [symbol] , [symbol] represents the data transmission cost of two tasks in a cloud server network, which is used to represent the network overhead per unit time of data transmission, and [symbol] represents all the pre-tasks of the task [symbol] ;

the following particle swarm formula is used to update the speed c and the position x:

$${v}_{i , d}^{t + 1} = ω \text{?} v \text{?} + {r}_{1} {c}_{1} ( p \text{?} - x \text{?} ) + {r}_{2} {c}_{2} ( g \text{?} - x \text{?} ) \qquad ( 22 )$$

$${x}_{i , d}^{t - 1} = {x}_{i , d}^{t} + {v}_{i , d}^{t + 1}$$

$$\text{?} \text{indicates text missing or illegible when filed}$$

the formula of the probability update speed v and the position x is as follows:

$$p ( x \text{?} \to x \text{?} , v \text{?} \to v \text{?} ) = \{ \begin{matrix}1 & Cos t ( {x}^{t + 1} ) < Cos t ( {x}^{t} ) \\ e \text{?} & Cos t ( {x}^{t + 1} ) \geq Cos t ( {x}^{t} )\end{matrix} \qquad ( 23 )$$

$$\text{?} \text{indicates text missing or illegible when filed}$$

if [symbol] < [symbol] , [symbol] is updated, [symbol] is the individual information recording the found optimal particle; if a better is found, the newly found particle information replaces the previously stored old particle information; if in the search process, the particle finds [symbol] < [symbol] , [symbol] < [symbol] , [symbol] < [symbol] , [symbol] < [symbol] , the corresponding [symbol] is updated;

when i=4k+2:

the particle i uses the following evaluation function:

$$Makespan = {{max}_{i = 1}}^{N} \{ Makespan \text{?} \} \qquad ( 24 )$$

$$\text{?} \text{indicates text missing or illegible when filed}$$

the following particle swarm formula is used to update the speed v and the position x:

$${v}_{i , d}^{t + 1} = ω \text{?} v \text{?} + {r}_{1} {c}_{1} ( p \text{?} - x \text{?} ) + {r}_{2} {c}_{2} ( g \text{?} - x \text{?} ) \qquad ( 25 )$$

$${x}_{i , d}^{t - 1} = {x}_{i , d}^{t} + {v}_{i , d}^{t + 1}$$

$$\text{?} \text{indicates text missing or illegible when filed}$$

the formula of the probability update speed v and the position x is as follows:

$$p ( x \text{?} \to x \text{?} , v \text{?} \to v \text{?} ) = \{ \begin{matrix}1 & Makespan ( {x}^{t + 1} ) < Makespan ( x \text{?} ) \\ e \text{?} & Makespan ( {x}^{t + 1} ) \geq Makespan ( x \text{?} )\end{matrix} \qquad ( 26 )$$

$$\text{?} \text{indicates text missing or illegible when filed}$$

if [symbol] < [symbol] , [symbol] is updated, if the particle finds [symbol] < [symbol] , [symbol] < [symbol] , [symbol] − [symbol] , [symbol] < [symbol] , the corresponding [symbol] is updated;

when i=4k+3:

the particle i uses the following evaluation function:

$$LD = \frac{\sqrt{{\sum }_{\text{?}}^{M} {( ET \text{?} - {AVE}_{ET} )}^{2}}}{M} \qquad ( 27 )$$

$$\text{?} \text{indicates text missing or illegible when filed}$$

the following particle swarm formula is used to update the speed v and the position x:

$${v}_{i , d}^{t + 1} = ω v \text{?} + {r}_{1} {c}_{1} ( p \text{?} - x \text{?} ) + {r}_{2} {c}_{2} ( g \text{?} - x \text{?} ) \qquad ( 28 )$$

$${x}_{i , d}^{t - 1} = {x}_{i , d}^{t} + {v}_{i , d}^{t + 1}$$

$$\text{?} \text{indicates text missing or illegible when filed}$$

the formula of the probability update speed v and the position x is as follows:

$$p ( x \text{?} \to x \text{?} , v \text{?} \to v \text{?} ) = \{ \begin{matrix}1 & LD ( x \text{?} ) < LD ( {x}^{t} ) \\ e \text{?} & LD ( x \text{?} ) \geq LD ( {x}^{t} )\end{matrix} \qquad ( 29 )$$

$$\text{?} \text{indicates text missing or illegible when filed}$$

if [symbol] < [symbol] , [symbol] is updated, if the particle finds [symbol] < [symbol] , [symbol] < [symbol] , [symbol] < [symbol] , [symbol] < [symbol] , the corresponding [symbol] is updated;

when i=4k+4:

the particle i uses the following comprehensive evaluation function:

Fitness=xᵢ*Cost+x₂*Makespan+x₃*LD (30)

the following particle swarm formula is used to update the speed V and the position x:

$${v}_{i , d}^{t + 1} = ω \text{?} v \text{?} + {r}_{1} {c}_{1} ( p \text{?} - x \text{?} ) + {r}_{2} {c}_{2} ( g \text{?} - x \text{?} ) \qquad ( 31 )$$

$${x}_{i , d}^{t - 1} = {x}_{i , d}^{t} + {v}_{i , d}^{t + 1}$$

$$\text{?} \text{indicates text missing or illegible when filed}$$

the formula of the probability update speed v and the position x is as follows:

$$p ( {x}^{\text{?}} \to {x}^{\text{?}} , {v}^{\text{?}} \to {v}^{\text{?} + 1} ) = \{ \begin{matrix}1 & Fitness ( {x}^{\text{?}} ) < Fitness ( {x}^{\text{?}} ) \\ e \frac{\text{?}}{T} & Fitness ( {x}^{\text{?}} ) \geq Fitness ( {x}^{\text{?}} )\end{matrix} \qquad ( 32 )$$

$$\text{?} \text{indicates text missing or illegible when filed}$$

if [symbol] < [symbol] , [symbol] is updated, if the particle finds [symbol] < [symbol] , [symbol] < [symbol] , [symbol] < [symbol] , [symbol] < [symbol] , the corresponding [symbol] is updated:

after the above execution process, updating k: k=k+1, updating c: c=c+1, and jumping back to step 2);

step 3) judging whether the iteration number is less than or equal to D, otherwise, jumping to step 4); starting to update the speed v and the position x of n particles using For loop:

n particles all use the following comprehensive evaluation function:

Fitness=x₁*Cost+x₂*Makespan+x₃*LD (33)

the following particle swarm formula is used to update the speed and the position x:

$${v}_{i , d}^{t + 1} = ω \text{?} v \text{?} + {r}_{1} {c}_{1} ( p \text{?} - x \text{?} ) + {r}_{2} {c}_{2} ( g \text{?} - x \text{?} ) \qquad ( 34 )$$

$${x}_{i , d}^{t - 1} = {x}_{i , d}^{t} + {v}_{i , d}^{t + 1}$$

$$\text{?} \text{indicates text missing or illegible when filed}$$

the judging formula of updating the speed and the position x is as follows:

$$p ( {x}^{\text{?}} \to {x}^{\text{?}} , {v}^{\text{?}} \to {v}^{\text{?} + 1} ) = \{ \begin{matrix}1 & Fitness ( {x}^{\text{?}} ) < Fitness ( {x}^{\text{?}} ) \\ e \frac{\text{?}}{T} & Fitness ( {x}^{\text{?}} ) \geq Fitness ( {x}^{\text{?}} )\end{matrix} \qquad ( 35 )$$

$$\text{?} \text{indicates text missing or illegible when filed}$$

if [symbol] < [symbol] , [symbol] is updated, if [symbol] < [symbol] , the corresponding [symbol] is updated;

step 4) outputting the final result, and scheduling the workflow to the corresponding virtual machine using a scheduler (a module responsible for scheduling tasks to the corresponding virtual machine); checking whether there is a new workflow coming, if so, starting a new cycle, if not, ending the process.

A workflow scheduling system based on a multi-target particle swarm algorithm is provided, comprising the following program modules:

an overhead evaluating module, which is configured to construct a workflow execution overhead evaluation equation;

an execution time evaluating module, which is configured to construct a workflow execution time evaluation equation;

a cluster load evaluating module, which is configured to construct a cluster load evaluation equation;

a solving module, which is configured to construct a comprehensive evaluation equation containing the indexes in the above three evaluation equations, and schedule the workflow using the particle swarm optimization algorithm for the workflow execution overhead evaluation equation, the workflow execution time evaluation equation, the cluster load evaluation equation and the comprehensive evaluation equation, wherein the particle swarm optimization algorithm (PSO) divides the particle swarm into four parts evenly, it is assumed that each part of particles is iterated for C times, the first C*a% iterations of each part of particles search for the optimal solutions of the above four evaluation equations, respectively, and the last C*(1−a%) iterations search for the optimal solution of the comprehensive evaluation equation.

A computer readable storage medium is provided, which is used to store the workflow scheduling method based on the multi-target particle swarm algorithm described above.

The above embodiments are only used to illustrate the technical scheme of the present disclosure, rather than limit e the technical scheme. Researchers in the field can still make modifications or equivalent substitutions to the detailed description of embodiments of the present disclosure by referring to the above embodiments. Any modifications or equivalent substitutions that do not depart from the spirit and scope of the present disclosure are within the scope of protection of the pending claims of the present disclosure.

What is claimed is:

1. A workflow scheduling method based on a multi-target particle swarm algorithm, comprising the following steps:
1) constructing a workflow execution overhead evaluation equation;
2) constructing a workflow execution time evaluation equation;
3) constructing a cluster load evaluation equation;
4) constructing a comprehensive evaluation equation containing the indexes in the above three evaluation equations, and scheduling the workflow using the particle swarm optimization algorithm for the workflow execution overhead evaluation equation, the workflow execution time evaluation equation, the cluster load evaluation equation and the comprehensive evaluation equation, wherein the particle swarm optimization algorithm divides the particle swarm into four parts evenly, it is assumed that each part of particles is iterated for C times, the first % iterations of each part of particles search for the optimal solutions of the above four evaluation equations, respectively, the last C*(1−a%) iterations search for the optimal solution of the comprehensive evaluation equation, and the value range of coefficient a is [0,100].

2. The workflow scheduling method based on the multi-target particle swarm algorithm according to claim 1, wherein:
in step 1), the workflow execution overhead evaluation equation includes the workflow execution overhead and the data transmission cost of a pre-task and a post-task, and the formula is:
$$Cos t = {\sum }_{\text{?}}^{M} {\sum }_{\text{?}}^{N} {k}_{\text{?}} * {ET}_{\text{?}} * {Price}_{\text{?}} + {\sum }_{\text{?}}^{N} {\sum }_{\text{?}}^{PR \text{?}} {TT}_{\text{?}} * {Price}_{\text{?}} \qquad ( 4 )$$
$${k}_{{t}_{i} {vm}_{j}} = \{ \begin{matrix}1 & {t}_{i} is executed on {vm}_{j} \\ 0 & {t}_{i} is not executed on {vm}_{j}\end{matrix} \qquad ( 5 )$$
$$Cos t \leq revenue \qquad ( 6 )$$
$$\text{?} \text{indicates text missing or illegible when filed}$$
where the number of tasks in the workflow is N, the number of virtual machines is M, [symbol] is a two-dimensional variable, [symbol] represents the execution time of the task [symbol] in the virtual machine [symbol] , [symbol] , represents the execution cost coefficient of a task in a virtual machine [symbol] , which is used to represent the overhead per unit time of a server executing a task. [symbol] represents the time it takes for a task [symbol] to complete data transmission to a task [symbol] , [symbol] represents the data transmission cost of two tasks in a cloud server network, which is used to represent the network overhead per unit time of data transmission, [symbol] represents all the pre-tasks of the task [symbol] , and the total overhead Cost of the workflow does not exceed the overhead limit revenue of a user.

3. The workflow scheduling method based on the multi-target particle swarm algorithm according to claim 1, wherein:
in step 2), the completion time of the task [symbol] is represented by [symbol] , and the execution time of the workflow is represented by the maximum completion time of its subtasks [symbol] , in which the target equation of the completion time of the task [symbol] includes the execution time and the waiting time of the task [symbol] , the waiting time of the task [symbol] includes the maximum execution time of all pre-tasks and the data time transmitted from all pre-tasks to the post-tasks, and the formula is as follows:
$${WT}_{\text{?}} = {\sum }_{\text{?}}^{PR \text{?}} {TT}_{\text{?}} + {max}_{\text{?}} \{ {ET}_{\text{?}} \} \qquad ( 7 )$$
$$\text{?} \text{indicates text missing or illegible when filed}$$
where [symbol] represents the waiting execution time of the task [symbol] , [symbol] represents all the pre-tasks of the task [symbol] , [symbol] represents the time it takes for the task [symbol] to complete data transmission to the task [symbol] , and [symbol] represents the execution time of [symbol] on [symbol] ; [symbol] represents the execution time of all pre-tasks of the task [symbol] on [symbol] (this is a set), and the maximum value is selected from the set;
the completion time of the task [symbol] is by [symbol] , and the formula is as follows:
$$Makespan \text{?} = WT \text{?} + ET \text{?} \qquad ( 8 )$$
$$\text{?} \text{indicates text missing or illegible when filed}$$
where [symbol] represents the waiting execution time of the task [symbol] , and [symbol] represents the execution time of [symbol] on [symbol] ;
the execution time evaluation equation of the workflow is as follows:
$$Makespan = {{max}_{\text{?}}}^{\text{?}} \{ {Makespan}_{\text{?}} \} \qquad ( 9 )$$
$$\text{?} \text{indicates text missing or illegible when filed}$$
where the number of the workflow tasks is N, [symbol] represents the maximum completion time of the task [symbol] .

4. The workflow scheduling method based on the multi-target particle swarm algorithm according to claim 1, wherein:
in step 3), the load balance evaluation equation is established according to the difference of the execution time of the server, that is, it is expressed by the variance of the task execution time of a single virtual machine and the average task execution time of a virtual machine cluster, and the smaller variance indicates that the server load is more balanced, in which the total time equation of the execution task of a single virtual machine is as follows:
$${ET}_{\text{?}} = {\sum }_{j = 1}^{N} {k}_{\text{?}} * {ET}_{\text{?}} \qquad ( 10 )$$
$${k}_{{t}_{2} {v}_{j}} = \{ \begin{matrix}1 & {t}_{j} is executed on {v}_{i} \\ 0 & {t}_{j} is not executed on {v}_{i}\end{matrix} \qquad ( 11 )$$
$$\text{?} \text{indicates text missing or illegible when filed}$$
where the total number of tasks in the workflow is N, [symbol] is a two-dimensional variable, and [symbol] represents the execution time of [symbol] on [symbol] ,
the average task execution time [symbol] of the virtual machine is:
$${AVE}_{\text{?}} = \frac{{\sum }_{\text{?}}^{M} {\sum }_{\text{?}}^{N} {k}_{\text{?}} * {ET}_{\text{?}}}{M} = \frac{{\sum }_{i}^{M} {ET}_{\text{?}}}{M} \qquad ( 12 )$$
$$\text{?} \text{indicates text missing or illegible when filed}$$
in the above formula, the number of tasks in the workflow is N, the number of virtual machines is M, [symbol] represents the execution time of [symbol] on [symbol] , [symbol] , is a two-dimensional variable, [symbol] represents the total time of the task execution in the virtual machine [symbol] ,
the maximum load target equation of the server cluster is expressed by the variance of the execution time of each virtual machine workflow and the average execution time of the total virtual machine workflow, and the equation expression is as follows:
$$LD = \frac{\sqrt{{\sum }_{\text{?}}^{M} {( {ET}_{\text{?}} - {AVE}_{\text{?}} )}^{2}}}{M} \qquad ( 13 )$$
$$\text{?} \text{indicates text missing or illegible when filed}$$
where the number of virtual machines is M, [symbol] represents the total time of the task execution of the virtual machine [symbol] , [symbol] represents the average time of the task execution of the virtual machine, LD represents the workload of the virtual machine cluster, and the smaller LD indicates that the load of the virtual machine is more balanced.

5. The workflow scheduling method based on the multi-target particle swarm algorithm according to claim 1, wherein:
in step 4), the workflow comprehensive evaluation equation consists of the workflow execution overhead evaluation equation, the workflow execution time evaluation equation and the cluster load evaluation equation, and the equation expressions are as follows:
Fitness=x₁*Cost+x₂*Makespan+x₃*LD (14)
Cost≥revenue (15)
Makespan≥D (16)
where x₁, x₂, and x₃ are the overhead weight coefficient, the time weight coefficient and the cluster load weight coefficient, respectively, and the weight coefficient varies with the characteristics of the task; Cost represents the workflow execution overhead; D represents the deadline of the workflow; Makespan represents the workflow execution time, and LD represents the workload of the virtual machine cluster.

6. The workflow scheduling method based on the multi-target particle swarm algorithm according to claim 1, wherein:
in step 4), the specific execution flow of the particle swarm optimization scheduling algorithm includes the following steps:
step 1), the particle swarm initializing the total iteration number C, the inertia factor ω, the acceleration constant [symbol] and the acceleration constant [symbol] , the random number [symbol] and the random number [symbol] , t=1, the particle grouping coefficient k=0, i=1, initializing the number n of the particle swarms, randomly generating n particles, representing the individual extremum [symbol] of particles using the execution overhead evaluation equation and the global extremum [symbol] of particles using the execution overhead evaluation equation by the execution overhead evaluation equation Cost, representing the individual extremum [symbol] of particles using the execution time evaluation equation and the global extremum [symbol] of particles using the execution time evaluation equation by the execution time evaluation equation Makespan, representing the individual extremum [symbol] of particles using the cluster load evaluation equation and the global extremum [symbol] of particles using the cluster load evaluation equation by the cluster load evaluation equation LD, representing the individual extremum [symbol] of particles using the workflow comprehensive evaluation equation and the global extremum [symbol] of particles using the workflow comprehensive evaluation equation by the workflow comprehensive evaluation equation Fitness, and each dimension of particles represents each workflow;
step 2), judging whether the iteration number is less than or equal to C*a%, otherwise, jumping to step 3; starting to update the speed v and the position x of n particle swarms using For loop i=1:n , and in order to reduce the negative effect of the complexity increase caused by the multi-target particle swarm, using an alternating update method:
when i=4k+1:
the particle uses the following evaluation equation:
$$Cos t = {\sum }_{\text{?}}^{M} {\sum }_{\text{?}}^{N} {k}_{\text{?}} * {ET}_{\text{?}} * {Price}_{\text{?}} + {\sum }_{\text{?}}^{N} {\sum }_{\text{?}}^{PR \text{?}} {TT}_{\text{?}} * {Price}_{\text{?}} \qquad ( 21 )$$
$$\text{?} \text{indicates text missing or illegible when filed}$$
where the number of tasks in the workflow is N, the number of virtual machines is M, [symbol] is a two-dimensional variable, [symbol] represents the execution time of the task [symbol] in the virtual machine [symbol] , [symbol] represents the execution cost coefficient of a task in a virtual machine [symbol] , which is used to represent the overhead per unit time of a server executing a task, [symbol] represents the time it takes for a task [symbol] to complete data transmission to a task [symbol] , [symbol] represents the data transmission cost of two tasks in a cloud server network, which is used to represent the network overhead per unit time of data transmission, and [symbol] represents all the pre-tasks of the task the following particle swarm formula is used to update the speed v and the position x:
$${v}_{i , d}^{t - 1} = ω \text{?} v \text{?} + {r}_{1} {c}_{1} ( p \text{?} - x \text{?} ) + {r}_{2} {c}_{2} ( g \text{?} - x \text{?} ) \qquad ( 22 )$$
$${x}_{i , d}^{t + 1} = {x}_{i , d}^{t} + {v}_{i , d}^{t + 1}$$
$$\text{?} \text{indicates text missing or illegible when filed}$$
the formula of the probability update speed v and the position x is as follows:
$$p ( {x}^{\text{?}} \to {x}^{\text{?}} , {v}^{\text{?}} \to {v}^{\text{?} + 1} ) = \{ \begin{matrix}1 & Cos t ( {x}^{\text{?}} ) < Cos t ( {x}^{\text{?}} ) \\ e \frac{\text{?}}{T} & Cos t ( {x}^{\text{?}} ) \geq Cos t ( {x}^{\text{?}} )\end{matrix} \qquad ( 23 )$$
$$\text{?} \text{indicates text missing or illegible when filed}$$
if [symbol] < [symbol] , [symbol] is updated, [symbol] is the individual information recording the found optimal particle; if a better is found, the newly found particle information replaces the previously stored old particle information; if in the search process, the particle finds [symbol] < [symbol] , [symbol] < [symbol] , [symbol] < [symbol] , [symbol] < [symbol] , the corresponding is updated:
when i=4k+2:
the particle i uses the following evaluation function:
$$Makespan = {{max}_{i = 1}}^{N} \{ Makespan \text{?} \} \qquad ( 24 )$$
$$\text{?} \text{indicates text missing or illegible when filed}$$
the following particle swarm formula is used to update the speed v and the position x:
$$v \text{?} = ω \text{?} v \text{?} + {r}_{1} {c}_{1} ( p \text{?} - x \text{?} ) + {r}_{2} {c}_{2} ( g \text{?} - x \text{?} ) \qquad ( 25 )$$
$${x}_{i , d}^{t + 1} = {x}_{i , d}^{t} + {v}_{i , d}^{t - 1}$$
$$\text{?} \text{indicates text missing or illegible when filed}$$
the formula of the probability update speed v and the position x is as follows:
$$p ( {x}^{\text{?}} \to {x}^{\text{?}} , {v}^{\text{?}} \to {v}^{\text{?} + 1} ) = \{ \begin{matrix}1 & Makespan ( {x}^{\text{?}} ) < Makespan ( {x}^{\text{?}} ) \\ e \frac{\text{?}}{T} & Makespan ( {x}^{\text{?}} ) \geq Makespan ( {x}^{\text{?}} )\end{matrix} \qquad ( 26 )$$
$$\text{?} \text{indicates text missing or illegible when filed}$$
if [symbol] < [symbol] , [symbol] is updated, if the particle finds [symbol] < [symbol] , [symbol] < [symbol] , [symbol] < [symbol] , [symbol] < [symbol] , the corresponding [symbol] is updated;
when i=4k+3:
the particle i uses the following evaluation function:
$$LD = \frac{\sqrt{{\sum }_{\text{?}}^{M} {( {ET}_{\text{?}} - {AVE}_{\text{?}} )}^{2}}}{M} \qquad ( 27 )$$
$$\text{?} \text{indicates text missing or illegible when filed}$$
the following particle swarm formula is used to update the speed v and the position x:
$$v \text{?} = ω v \text{?} + {r}_{1} {c}_{1} ( p \text{?} - x \text{?} ) + {r}_{2} {c}_{2} ( g \text{?} - x \text{?} ) \qquad ( 28 )$$
$${x}_{i , d}^{t + 1} = {x}_{i , d}^{t} + {v}_{i , d}^{t - 1}$$
$$\text{?} \text{indicates text missing or illegible when filed}$$
the formula of the probability update speed v and the position x is as follows:
$$p ( {x}^{\text{?}} \to {x}^{\text{?}} , {v}^{\text{?}} \to {v}^{\text{?} + 1} ) = \{ \begin{matrix}1 & LD ( {x}^{\text{?}} ) < LD ( {x}^{\text{?}} ) \\ e \frac{\text{?}}{T} & LD ( {x}^{\text{?}} ) \geq LD ( {x}^{\text{?}} )\end{matrix} \qquad ( 29 )$$
$$\text{?} \text{indicates text missing or illegible when filed}$$
if [symbol] < [symbol] , [symbol] is updated, if the particle finds [symbol] < [symbol] , [symbol] < [symbol] , [symbol] < [symbol] , [symbol] < [symbol] , the corresponding [symbol] is updated;
when i=4k+4:
the particle i uses the following comprehensive evaluation function:
Fitness=x₁*Cost+x₂*Makespan+x₃*LD (30)
the following particle swarm formula is used to update the speed v and the position x:
$$v \text{?} = ω \text{?} v \text{?} + {r}_{1} {c}_{1} ( p \text{?} - x \text{?} ) + {r}_{2} {c}_{2} ( g \text{?} - x \text{?} ) \qquad ( 31 )$$
$${x}_{i , d}^{t + 1} = {x}_{i , d}^{t} + {v}_{i , d}^{t - 1}$$
$$\text{?} \text{indicates text missing or illegible when filed}$$
the formula of the probability update speed v and the position x is as follows:
$$p ( {x}^{\text{?}} \to {x}^{\text{?}} , {v}^{\text{?}} \to {v}^{\text{?} + 1} ) = \{ \begin{matrix}1 & Fitness ( {x}^{\text{?}} ) < Fitness ( {x}^{\text{?}} ) \\ e \frac{\text{?}}{T} & Fitness ( {x}^{\text{?}} ) \geq Fitness ( {x}^{\text{?}} )\end{matrix} \qquad ( 32 )$$
$$\text{?} \text{indicates text missing or illegible when filed}$$
if [symbol] < [symbol] , [symbol] is updated, if the particle finds [symbol] < [symbol] [symbol] < [symbol] , [symbol] < [symbol] , [symbol] < [symbol] , the corresponding [symbol] is updated;
after the above execution process, updating k: k=k+1, updating c: c=c+1, and jumping back to step 2);
step 3) judging whether the iteration number is less than or equal to D, otherwise, jumping to step 4); starting to update the speed v and the position x of n particles using For loop:
n particles all use the following comprehensive evaluation function:
Fitness=x₁*Cost+x₂*Makespan+x₃*LD (33)
the following particle swarm formula is used to update the speed v and the position x:
$$v \text{?} = ω \text{?} v \text{?} + {r}_{1} {c}_{1} ( p \text{?} - x \text{?} ) + {r}_{2} {c}_{2} ( g \text{?} - x \text{?} ) \qquad ( 34 )$$
$$x \text{?} = {x}_{i , d}^{t} + v \text{?}$$
$$\text{?} \text{indicates text missing or illegible when filed}$$
the judging formula of updating the speed v and the position x is as follows:
$$p ( {x}^{\text{?}} \to {x}^{\text{?}} , {v}^{\text{?}} \to {v}^{\text{?} + 1} ) = \{ \begin{matrix}1 & Fitness ( {x}^{\text{?}} ) < Fitness ( {x}^{\text{?}} ) \\ e \frac{\text{?}}{T} & Fitness ( {x}^{\text{?}} ) \geq Fitness ( {x}^{\text{?}} )\end{matrix} \qquad ( 35 )$$
$$\text{?} \text{indicates text missing or illegible when filed}$$
if [symbol] < [symbol] , [symbol] is updated, if [symbol] the corresponding [symbol] is updated;
step 4) outputting the final result, and scheduling the workflow to the corresponding \initial machine using a scheduler; checking whether there is a new workflow coming, if so, starting a new cycle, if not, ending the process.

7. A workflow scheduling system based on a multi-target particle swarm algorithm, comprising the following program modules:
an overhead evaluating module, which is configured to construct a workflow execution overhead evaluation equation;
an execution time evaluating module, which is configured to construct a workflow execution time evaluation equation;
a cluster load evaluating module, which is configured to construct a cluster load evaluation equation:
a solving module, which is configured to construct a comprehensive evaluation equation containing the indexes in the above three evaluation equations, and schedule the workflow using the particle swarm optimization algorithm for the workflow execution overhead evaluation equation, the workflow execution time evaluation equation, the cluster load evaluation equation and the comprehensive evaluation equation, wherein the particle swarm optimization algorithm (PSO) divides the particle swarm into four parts evenly, it is assumed that each part of particles is iterated for C times, the first C*a% iterations of each part of particles search for the optimal solutions of the above four evaluation equations, respectively, and the last C*(1−a%) iterations search for the optimal solution of the comprehensive evaluation equation.

8. A computer readable storage medium, which is used to store the workflow scheduling method based on the multi-target particle swarm algorithm according to claim 1.
